(19) United States
(12) Patent Application Publication
(10) Pub. No.: US 2012/0014130 A1
(43) Pub. Date: Jan. 19, 2012

(54) LIGHT FILTERED KEY TOP BEZEL

(76) Inventor: Jit Ming Bryan Lim, Woodlands Spectrum (SG)

(21) Appl. No.: 13/140,063

(22) PCT Filed: Dec. 17, 2008
(86) PCT No.: PCT/SG08/00488

§ 371 Date: Jun. 16, 2011

(51) Int. Cl. F21V 8/00; F21V 11/00

(52) U.S. Cl. 362/606; 362/236

(57) ABSTRACT

The present invention provides a light emitting key-top having stealth effect outlook. Particularly, the printing of background colours black, predetermined pattern printing blue and predetermined pattern printing red are all printed on the back side of the key-top. The light-up of coloured print patterns from the same colour light source is to distinguish the current operation mode on the communication devices or personal entertainment devices. Upon introduction of stealth key-top at zero mode or ‘off’ mode, the key-top will be black colour or background colour, when the red colour light source is switched on, only the red colour printed pattern will light-up and/or if blue colour light source is switch on, only the blue colour printed pattern is light up as shown in.

### 1. FIELD OF THE INVENTION

The present invention pertains to the field of light emitting key tops with stealth effect outlook and more particularly, to a light emitting key top for distinguishing the current operation mode when is light-up from colour light sources on communication or personal entertainment devices, by means of printing a background colour black, a predetermined pattern blue and a predetermined pattern red on the back side of the key-top.

### 2. BACKGROUND OF THE INVENTION

Generally, light emitting keypads and/or bezels are widely applied to facilitate data and command input for various portable devices in the consumer electronics industry. Said devices include mobile cellular phones, hand-held computers, pagers, personal organizers, entertaining devices, as well as musical players, television, radio, controlling devices, that include remote control allowing practical usage as a switch conducting various supplemental functions including signal generation, and particularly for distinguishing characters or modes of functions at night or in poor lighting conditions without affecting the keypad thickness.

In a conventional light emitting keypad the light source is of any single colour. The light source may be light emitting diodes (led's) and/or electroluminescent (EL) lamps. The background colour is achieved either by spray painting or by silkscreen printing or by non conductive vacuum metallization (NCVM) on the second surface of the key-top. The distinguishing patterns are hollow out from the background silkscreen mesh at a predetermined position or by chemical wash away to remove metallic coating that is covering the patterns if the NCVM method were used. This enables the selected colour to be filled into the pattern areas, which is left unprinted from the background printing. The distinguishing patterns or characters indicate an operation or function mode, which enables the user to know exactly which mode or function appliance is currently at.

However, the conventional key-top thus described suffers from a number of shortcomings that make it inefficient, particularly, where the modern communication devices are endowed with additional operation modes such as music player (mp) operation, digital camera operation, etc. The additional operation modes thus increase the number of functions the device must perform and/or must be user friendly where the user can easily identify the operation mode the device is at.

In order to solve the aforementioned shortcomings, a couple of considerations have been taken into account, providing a segmented led lights to avoid light leakage, or EL lamp with multi colour segment. However these considerations still have shortcomings, namely, high manufacturing difficulties, high energy consumption and additionally elevated cost factors, so that all these additional shortcomings also unable it to adapt into reality.

With additional operational modes, the light-emitting keypad must still be thin in thickness, must be energy saving, also maintaining or shortening the current manufacturing cost. Such objectives are achieved with a light filtered key top bezel as claimed in the appended claims.

### 3. BRIEF DESCRIPTION OF THE DRAWINGS

There follows a brief description of the drawings where same numeric references identify the same elements along all drawings.

FIG. 1 is a top view of a conventional keypad at “on” mode. The distinguishing patterns or characters are printed with different colours.

FIG. 2 is a cross section view of the conventional keypad showing various layers of ink and light source and distinguishing light source.

FIG. 3 is a top view of a first embodiment of the light emitting key top bezel of the present invention at “zero” or “off” mode, where the power supply to the light source is switched off.

FIG. 4 is a cross section view of the first embodiment of the light emitting key top bezel of the present invention showing various layers of ink and led light source.

FIG. 5 is the top view of the first embodiment of the light emitting key top bezel of the present invention with red colour printed pattern being lighted up when the red colour led power is switched on.

FIG. 6 is a cross section view of the first embodiment of the light emitting key top bezel of the present invention showing various layers of colour printing with only the red colour led switched on.

FIG. 7 is the top view of the first embodiment of the light emitting key top bezel of the present invention with the blue colour printed pattern being lighted up when the blue colour led power is switched on.

FIG. 8 is a cross section view of the first embodiment of the light emitting key top bezel of the present invention showing various layers of colour printing with only the blue colour leds switched on.

FIG. 9 is an exploded layer view of a second embodiment of the light emitting key top bezel of the present invention with direct led lamp illuminated key-top, depicting the constituent layers.

FIG. 10 is an exploded layer view of a second embodiment of the light emitting key top bezel of the present invention with direct EL lamp illuminated key-top, depicting the constituent layers.

FIG. 11 is an exploded layer view of a second embodiment of the light emitting key top bezel of the present invention with light-pipe illuminated key-top, depicting the constituent layers.

### 4. DETAILED DESCRIPTION OF THE INVENTION

The present invention is provided to solve the aforesaid shortcomings of the prior art and it is an object of the present invention to provide a keypad comprising a light filter key-top with an aesthetic ‘stealth’ and/or morphing effect, wherein the user can easily distinguish the operation the device is currently at. The specific pattern printed on the key-top allows lights of different colours, which is designed to command the current operation to filter through. Thus the user is able to control the device based on the operation mode the device is exactly in use. The combination of different colours and patterns create various matrixes that can be applied for various function controls on the telecommunication or electronic hand held appliances. Since we can have different light source options, thus it enable the designer to have a wider choice of types for lights source that can fit into their design, especially latest users who prefer small and compact devices which are handy and importantly as many multi media functions as possible.

In one general aspect, the key top bezel of the invention is disposed at top layer, which is also the cosmetic surface. The light source is below the key-top, which supplies the light to the top surface and is filtered through the translucent printed patents. This lighted pattern allows the user to know which operation mode the appliance is currently in use.

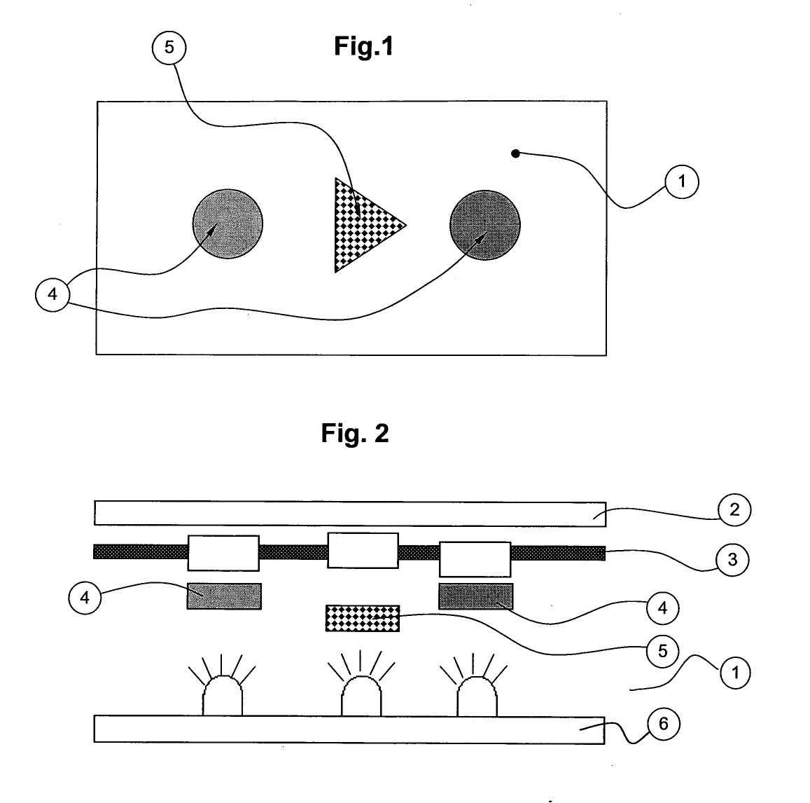

FIGS. 1 and 2 depict a conventional key top (1) comprising the following layers: red translucent icon (5); blue translucent icons (4); key top (2); opaque black core-out artwork (3); and single colour light source (6) (EL or led). The bezel or key top film layer (2) includes one or more materials selected from a group of UV mold print film, PMMA (poly methyl methacrylate) film, polycarbonate (pc) film, PET (polyethylene terephthalate) film and/or other clear and/or transparent film made of polymer or elastomer material.

Two preferred embodiments of the invention will be described below by way of examples in order to make the present disclosure more understandable, but these exemplary embodiments do not intend to limit the scope of the present invention which is defined by the appended claims.

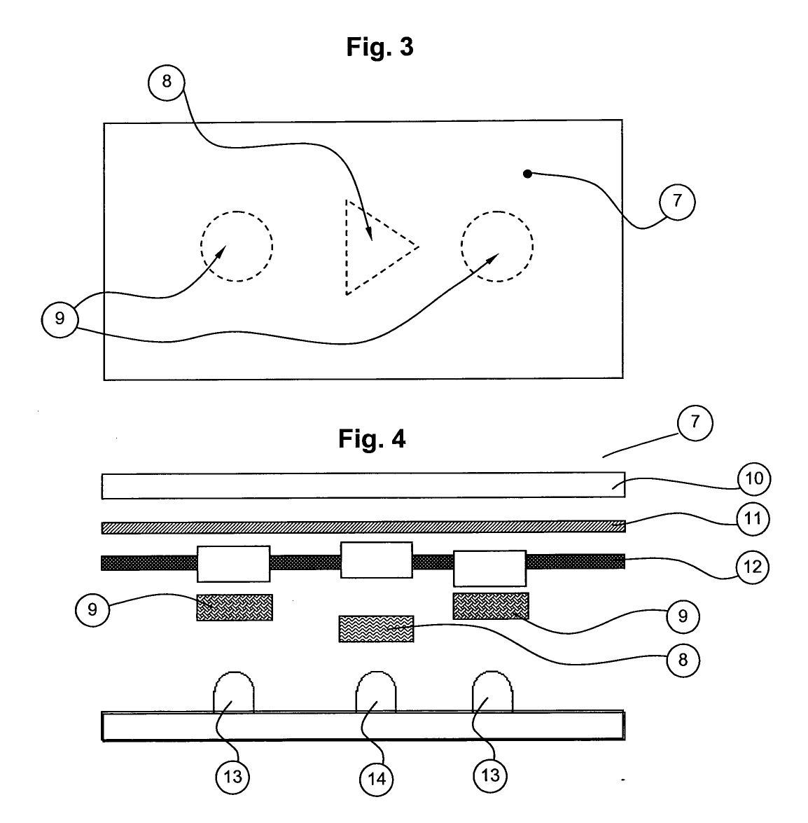

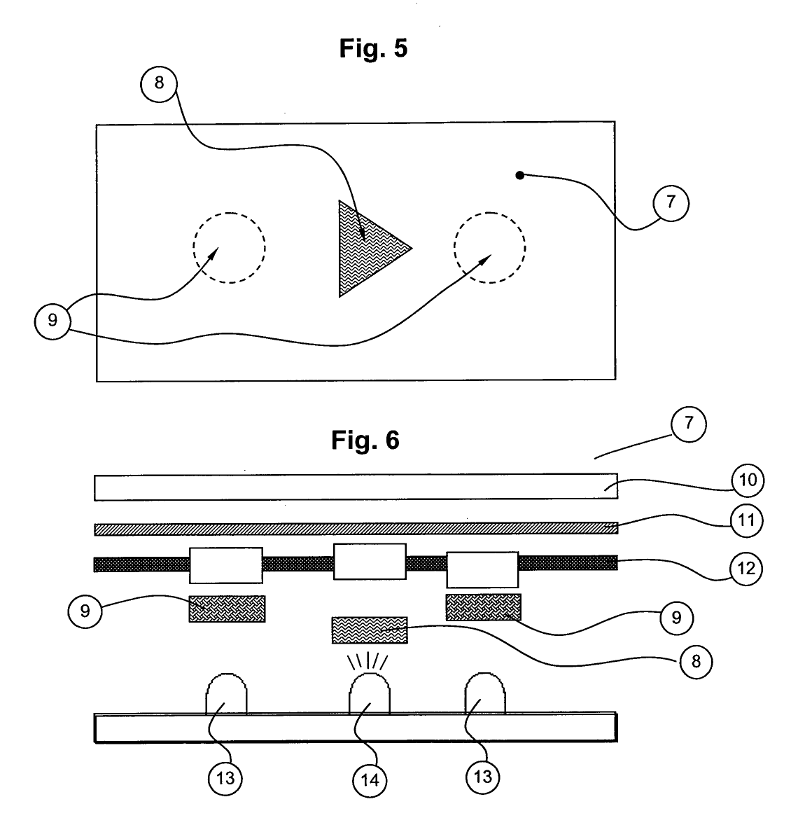

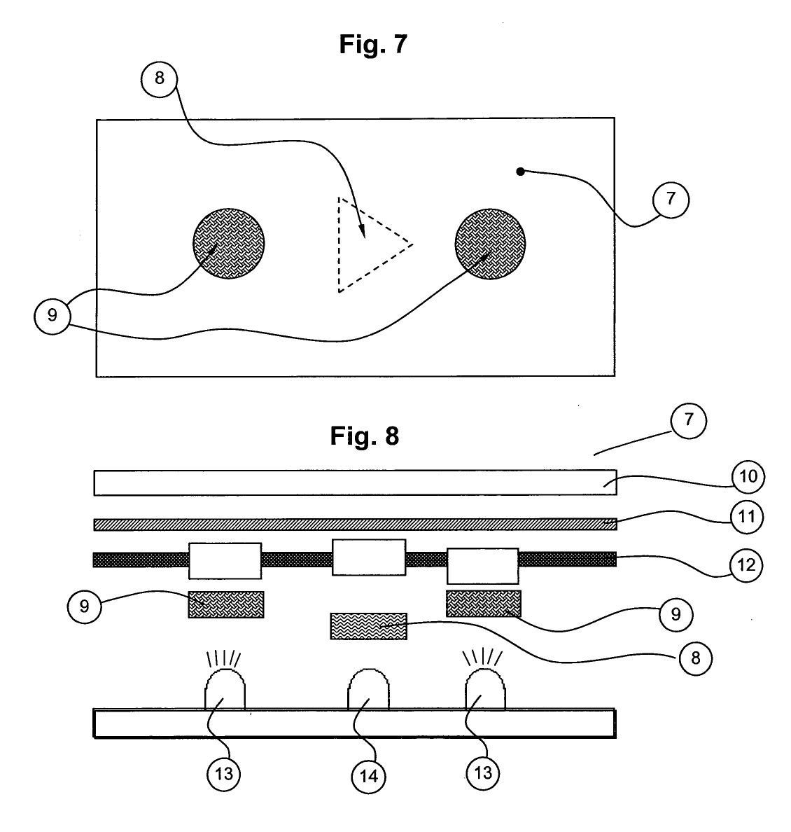

According to FIGS. 3-8 there is provided a first embodiment of the light emitting key top bezel (7) of the present invention comprising: a red translucent icon (8); blue translucent icons (9); a key top layer (10); a translucent black layer (11); an opaque black core-out artwork layer (12); and a colour light emitting or illuminating element with at least blue leds (13) and a red led (14). FIGS. 3-4 represent the key top bezel (7) in a “stealth” or non-illuminated mode because the blue and red leds (13, 14) are switched off. FIGS. 5-6 represent the key top bezel (7) in a first operation mode where only the red icon (8) is illuminated and the blue icons (9) are non-illuminated because the blue leds (13) are switched off and the red led (14) is switched on. FIGS. 7-8 represent the key top bezel (7) in a second operation mode where the red icon (8) is non-illuminated and the blue icons (9) are illuminated because the blue leds (13) are switched on and the red led (14) is switched off.

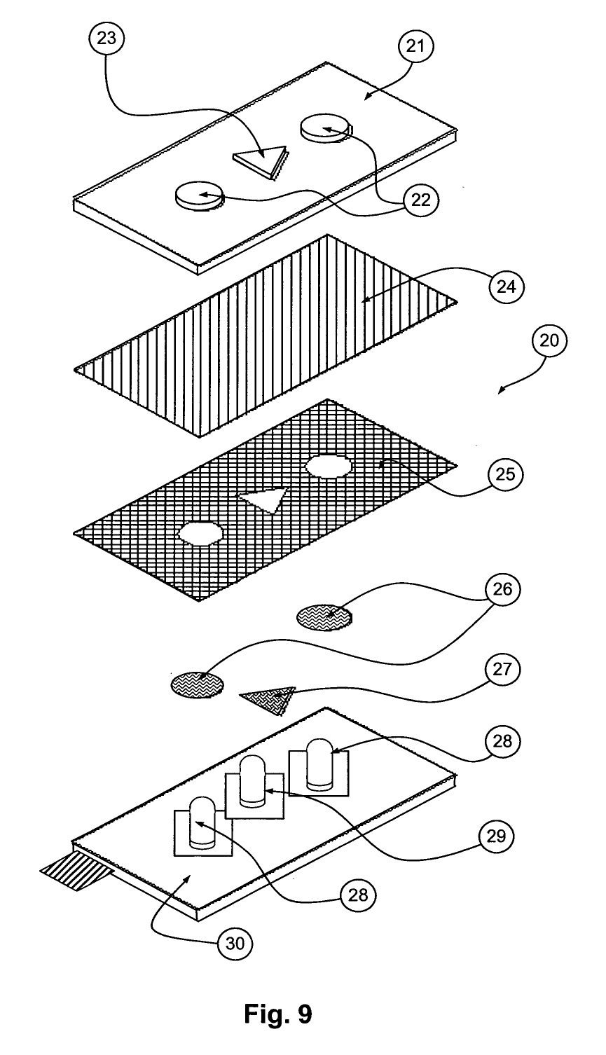

In reference now to FIGS. 9-11 there is provided a second embodiment of the light emitting key top bezel (20) of the present invention comprising: a key top layer (21); a blue button/icon (23); red buttons/icons (22); a translucent black layer (24); an opaque black-core-out artwork (printing) layer (25); red translucent (printing) patterns (26); blue translucent (printing) pattern (27); and a colour light emitting or illuminating element.

In FIG. 9, the key top (20) is direct led lamp illuminated, and the illuminating element consists of red led lamps (28); blue led lamp (29); and a printed circuit board (30) on which the led lamps are mounted directly below the printed patterns, the position being predetermined by the location of the printed pattern colours.

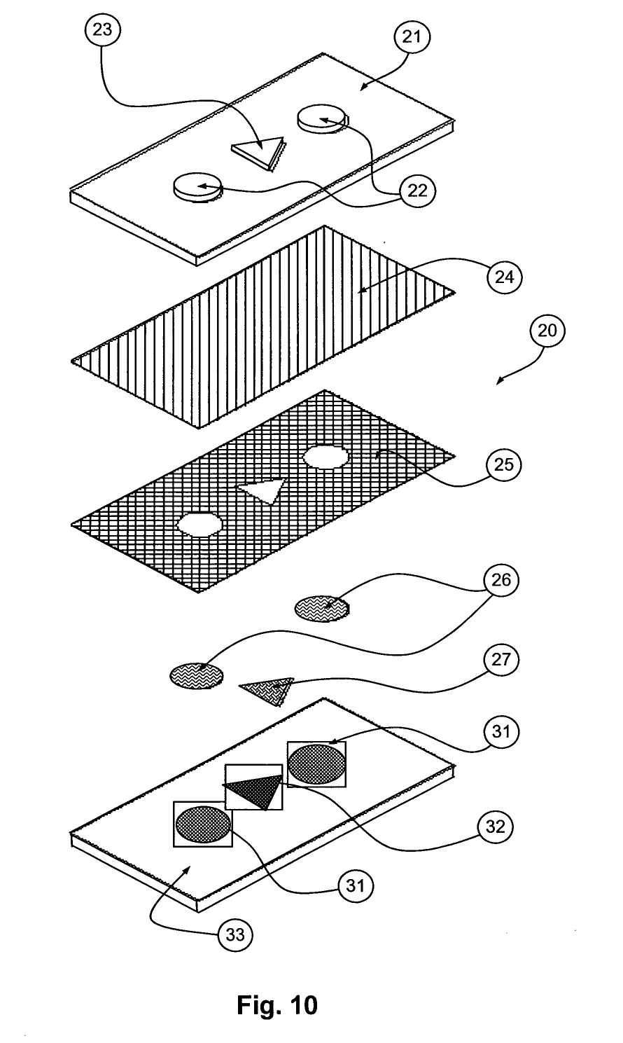

In FIG. 10, the key top (20) is direct electroluminescent lamp illuminated, and the illuminating element consists of red colour segments (31) and blue colour segment (32) printed on top of an electroluminescent lamp (33) directly below the printed patterns predetermined by the position of the printed pattern colours.

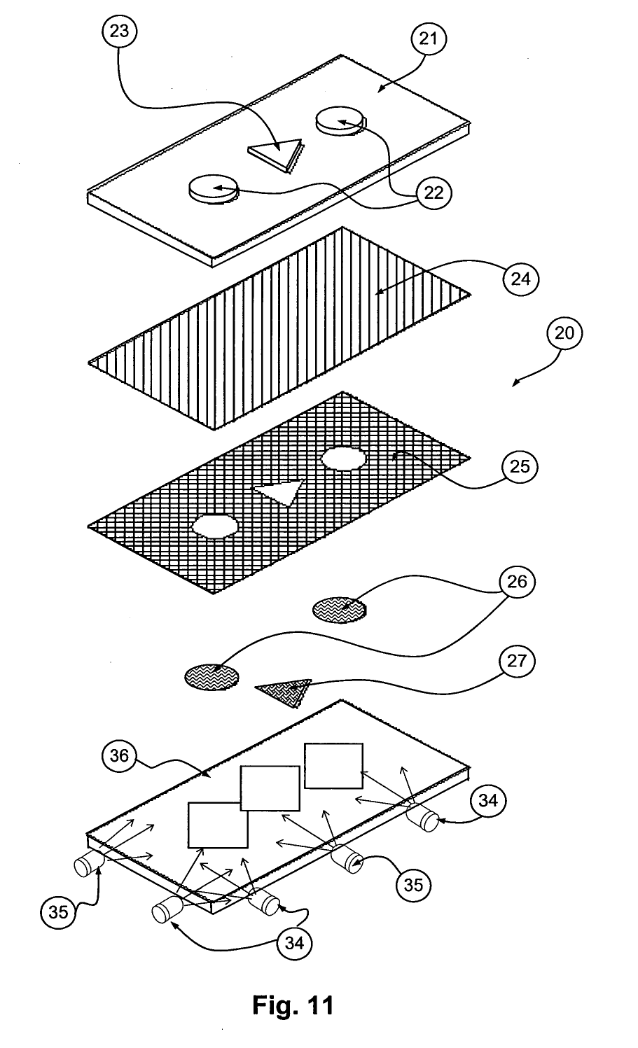

In FIG. 11, the key top (20) is indirect led lamp illuminated, and the illuminating element consists of red colour led lamps (34) and blue colour led lamps (35) mounted on the side of a light-pipe (36) preferably made of PC (polycarbonate) and/or PMMA (polymethyl methacrylate). The material of light guide should have an excellent light guiding capability, good elasticity and flexibility.

The bezel or key top film layer (10, 21) is a single sheet selected from the group consisting of mold print pc (polycarbonate) film and/or pmma (poly methyl methacrylate) film and/or PET (polyethylene terephthalate) film.

Furthermore, the film rear surface is printed with a background opaque colour layer (11, 24), leaving the pattern of distinguishing characters or icons, such that the colour use to filled the pattern are less dense than the background colour. This allows the light source to filter through the patterns, which indicate to the user the current function mode. The printed colour pattern and the light source must both be uniform and well balanced, particularly light source form the led (13, 14, 28, 29) source.

The background colour on the key top layer (7, 20) is formed on the second surface by spraying method, silkscreen method, tampo printing etc. The colour must be opaque so that no light can leak thru creating the stealth or morphing effect, except for the distinguish pattern area in which the characters or pattern are either masked or laser etched after the background colours is applied. The colour printed for the pattern area must be uniform and also translucent enough to allow lights to pass through it. The red and blue colour on the pattern can be printed either by silkscreen or tampo print method.

1. A light emitting key top bezel (7, 20) comprising:
a key top layer (10,21);
a translucent black layer (11, 24);
an opaque black core-out artwork layer (12, 25);
a coloured light emitting or illuminating element; and
a plurality of coloured icons (8, 9, 22, 23)
wherein said coloured light emitting element is adapted to emit, at a time, either none or one of a plurality of coloured lights being the number of coloured lights equal to the number of groups of different coloured icons.

2. The light emitting key top bezel (7, 20) according to claim 1, wherein said coloured lights are emitted from predetermined segmented areas or points of said light emitting element which are situated directly below of said coloured icons (8, 9, 22, 23) being each emitted coloured light of the same colour than the icon on top.

3. The light emitting key top bezel (7, 20) according to claim 1, wherein each of said groups of coloured icons identifies an operation mode.

4. The light emitting key top bezel (7, 20) according to claim 1, wherein said light emitting element comprises at least blue light emitting diodes (13, 29) and red light emitting diodes (14, 28).

5. The light emitting key top bezel (7, 20) according to claim 1, wherein said light emitting element comprises at least red colour segments (31) and blue colour segments (32) printed on top of an electroluminescent lamp (33).

6. The light emitting key top bezel (7, 20) according to claim 1, wherein said light emitting element comprises at least red colour led lamps (34) and blue colour led lamps (35) mounted laterally on a light pipe (36).

7. The light emitting key top bezel (7, 20) according to claim 6, wherein said light pipe (36) is made from a material with light guiding capability, elasticity and flexibility, preferably selected from polycarbonate or polymethyl metacrylate.

8. The light emitting key top bezel (20) according to claim 1, wherein said key top layer (10,21) is made from a film of a material selected from the group consisting of UV mold print, polycarbonate, polymethyl methacrylate, and polyethylene terephthalate.
